(19) United States
(12) Patent Application Publication
(10) Pub. No.: US 2009/0138537 A1
(43) Pub. Date: May 28, 2009

(54) Address generating circuit and semiconductor memory device

(75) Inventor: Hiroaki Iwaki, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: ELPIDA MEMORY INC., Tokyo (JP)

(21) Appl. No.: 12/292,257

(22) Filed: Nov. 14, 2008

(30) Foreign Application Priority Data
Nov. 22, 2007 (JP) 2007-303776

(51) Int. Cl. G06F 7/50

(52) U.S. Cl. 708/710

(57) ABSTRACT

An address generating circuit includes a first carry look-ahead circuit for performing an operation using an inputted first carry and a first address and outputting a first output address and a first output carry respectively as a first operation result, a second carry look-ahead circuit for performing an operation using a carry fixed to 0 and a second address and outputting a second output address and a second output carry respectively as a second operation result, a third carry look-ahead circuit for performing an operation using a carry fixed to 1 and the second address and outputting a third output address and a third output carry respectively as a third operation result, and a first select circuit for selecting either of the second and third operation results based on the first output carry and outputting the selected operation result.

### BACKGROUND OF THE INVENTION

1. Field of the Invention

The present invention relates to an address generating circuit which performs a predetermined operation based on an input address and an input carry and generates an output address, and particularly relates to an address generating circuit and a semiconductor memory device provided with the address generating circuit, having a configuration for inputting/outputting an address divided into segments each composed of several digits and for performing carry detection for an arithmetic operation.

2. Description of Related Art

Generally, a semiconductor memory device such as DRAM (Dynamic Random Access Memory) is provide with an address generating circuit for performing a predetermined operation such as addition with carry based on an address required in an access. An Operation with carry for an address composed of a large number of digits is necessary in such an address generating circuit. Conventionally, an address generating circuit having a configuration, for example, shown in FIG. 12 has been widely used. The address generating circuit as shown in FIG. 12 has a function for performing addition with carry for a nine-digit input address A[10:2]. Here, lower two bits of an eleven-digit address A[10:0] used for accessing is assumed not to be used in the operation. In FIG. 12, nine full adders (represented as FA) 200 are connected sequentially from a lower side in multiple stages, and a result of the addition with carry is outputted as a nine-digit output address AA[10:2]. A carry C1 is inputted to the least significant full adder 200 from outside, and carries C2 to C9 are propagated from each full adder 200 to upper sides sequentially.

FIG. 14 shows a timing chart of the address generating circuit of FIG. 12. First, a carry C1 is determined to 1 and the nine-digit input address A[10:2] is determined, respectively at timing T0. Then, the least significant output address AA2 and the carry C2 are outputted after a time tPD0 required for an arithmetic operation of the first full adder 200 is elapsed. Subsequently, the output addresses AA3 to AA10 and the carries C2 to C9 are outputted sequentially by the respective full adders 200. In this case, the outputting of the most significant address AA10 is completed at the point when a time TPDa is elapsed from the timing T0, and a relation of tPDa=tPD0×9 is satisfied. In this manner, according to the configuration of FIG. 12, as the number of digits of the address increases, operation time increases in proportion thereto.

Meanwhile, in order to achieve high-speed addition with carry, an address generating circuit having a configuration shown in FIG. 13 has been proposed. The address generating circuit shown in FIG. 13 has a function for performing the addition with carry for the nine-digit input address A[10:2] using the configuration different from that in FIG. 12. In FIG. 13, the nine-digit input address A[10:2] is divided into segments each composed of three digits, which are an upper input address A[10:8], a middle input address A[7:5] and a lower input address A[4:2]. Similarly, the nine-digit output address AA[10:2] is divided into segments each composed of three digits, which are an upper output address AA[10:8], a middle output address AA[7:5] and a lower output address AA[4:2].

Then, there are provided a carry look-ahead circuit 301 receiving the lower input address A[4:2] and the carry C1 and outputting the lower output address AA[4:2] and the carry C4, a carry look-ahead circuit 302 receiving the middle input address A[7:5] and the carry C4 and outputting the middle output address AA[7:5] and the carry C7, and a carry look-ahead circuit 303 receiving the upper input address A[10:8] and the carry C7 and outputting the upper output address AA[10:8]. Each of the carry look-ahead circuits 301, 302 and 303 includes a first full adder (represented as FA1) 401 and two second full adders (represented as FA2) 402 and 403, which perform three-digit addition with carry, and a carry detection circuit 404. Here, circuit configurations of these elements are shown in FIGS. 2 and 3.

FIG. 15 shows a timing chart of the address generating circuit of FIG. 13. The carry C1 is determined to be 1 and the nine-digit input address A[10:2] is determined, respectively at the timing T0, similarly as in FIG. 14. Then, the lower output address AA[4:2] and the carry C4 are outputted after the time tPD0 required for an arithmetic operation of the first carry look-ahead circuit 301 is elapsed. Subsequently, the middle output address AA[7:5] and the carry C7 are outputted from the carry look-ahead circuit 302 after the time tPD0 is further elapsed. Finally, the upper output address AA[10:8] is outputted from the carry look-ahead circuit 303 at the point when a time TPDb is elapsed from the timing T0. In this case, since a relation of tPDb=tPD0×3 is satisfied, the operation time can be further reduced than that in FIG. 15.

However, even when the configuration of FIG. 13 is employed, higher speed operation for an address having an increasing number of digits is restricted. That is, as understood from FIG. 15, the overall operation time TPDb is determined in proportion to the division number of the address, and therefore reducing the division number of the address is advantageous for the reduction of the operation time. However, if the division number of the address is decreased, each carry look-ahead circuit needs to be configured with multiple bits and carry detection needs to be performed using multistage gates. Therefore, this arises problems of an increase in area due to a complex circuit configuration and a decrease in margin in lower voltage operation.

As measures against such problems, a configuration in which carries need not to be transferred between adjacent carry look-ahead circuits has been proposed (for example, see Patent Reference 1). For example, the configuration in which carries C4 and C7 propagated from the lower side are inputted to the carry look-ahead circuits 302 and 303 as shown in FIG. 13 is not employed, however a carry look-ahead circuit in which a carry fixed to 0 is assumed to be inputted and a carry look-ahead circuit in which a carry fixed to 1 is assumed to be inputted are independently provided, respectively. Then, when a configuration in which operation results of both the carry look-ahead circuits are selectively outputted by a multiplexer (see FIG. 8), the arithmetic operation can be performed without waiting for carries to be propagated from the lower side, thereby being suitable for higher speed operation.

Patent Reference 1: Laid-open Japanese Patent Publication No. Hei 4-227533

However, assuming that the above-mentioned configuration is employed, when the division number of the address increase due to an increase in the number of digits, combinations of digits of the address increases since carries are assumed to be transferred at a larger number of points. For example, in the configuration of FIG. 13, there are four combinations of the carries C4 and C7 each being 0 or 1, and thus four circuits need to be configured (see FIG. 8). In this manner, the increase in the division number causes an increase in the number of the carry look-ahead circuits and complexity of the configuration of the multiplexer, so that an increase in area due to an increase in circuit scale becomes a problem.

### SUMMARY

The present invention seeks to solve the above problem and provides an address generating circuit in which when performing an arithmetic operation with carry, higher speed arithmetic operation can be achieved for a large number of digits of an address, and an increase in area due to an increase in circuit scale can be avoided.

In an aspect of the invention, there is provided an address generating circuit including a first carry look-ahead circuit for performing an operation using an inputted first carry and a first address and outputting a first output address and a first output carry respectively as a first operation result; a second carry look-ahead circuit for performing an operation using a carry fixed to 0 and a second address and outputting a second output address and a second output carry respectively as a second operation result; a third carry look-ahead circuit for performing an operation using a carry fixed to 1 and the second address and outputting a third output address and a third output carry respectively as a third operation result; and a first select circuit for selecting either of the second and third operation results based on the first output carry and outputting the selected operation result.

According to the address generating circuit of the present invention, the input address and the output address are divided respectively, and a plurality of address operation circuits are connected in multiple stages and output divided output addresses by performing an operation with carry based on divided input addresses. Then, in at least one address operation circuit, there are provided first and second carry look-ahead circuits whose caries are fixed to 0/1 without using carries propagated from the lower stage, and operation results of the both circuits are selectively outputted by the select circuit based on actual carries. Thus, the address operation circuit having such a configuration can perform operations in the carry look-ahead circuits simultaneously without waiting for carry detection of the preceding stage. Accordingly, when performing operation with carry for an address composed of a large number of digits, high-speed arithmetic operation can be achieved with a relatively small circuit scale.

The address generating circuit of the invention may further include a fourth carry look-ahead circuit for performing an operation using a carry fixed to 0 and a third address and outputting a fourth output address and a fourth output carry respectively as a fourth operation result, a fifth carry look-ahead circuit for performing an operation using a carry fixed to land the third address and outputting a fifth output address and a fifth output carry respectively as a fifth operation result, and a second select circuit for selecting either of the fourth and fifth operation results based on an output of the first select circuit and outputting the selected operation result.

In another aspect of the invention, there is provided an address generating circuit including the first, second and third carry look-ahead circuits and a second select circuit for selecting either of the fourth and fifth operation results based on an output of the first select circuit and outputting the selected operation result.

In another aspect of the invention, there is provided a semiconductor memory device including the first, second and third carry look-ahead circuits and the first select circuit.

As described above, according to the present invention, the address generating circuit which performs operation with carry for a plurality of divided addresses in address operation circuits connected in multiple stages. Operation outputs of two carry look-ahead circuits receiving carries fixed to 0 and 1 propagated from the lower side are selectively inputted to one of the address operation circuits based on actual carries. Thus, each carry look-ahead circuit can be individually operated without waiting for carries to be propagated from the lower side, and the result of the operation with carry can be obtained rapidly. Further, even when the division number of addresses is increased, it is unnecessary to select an operation result corresponding to a combination of carries by a multiplexer, and therefore an increase in the area can be avoided without a complex circuit configuration.

### BRIEF DESCRIPTION OF THE DRAWINGS

The above featured and advantages of the present invention will be more apparent from the following description of certain preferred embodiments taken in conjunction with the accompanying drawings, in which:

FIG. 1 is a block diagram showing an entire configuration of an address generating circuit of a first embodiment;

FIGS. 2A and 2B are diagrams showing circuit configurations of a first full adder 21 and second full adders 22 and 23 included in carry look-ahead circuits 11 to 15;

FIG. 3 is a diagram showing a circuit configuration of a carry detection circuit 24 included in each of the carry look-ahead circuits 11 to 15 and showing a connection relation in each of the carry look-ahead circuits 11 to 15;

FIG. 4 is a diagram showing an example of a timing chart for a case where no carry is generated for an input address A[10:2] in the address generating circuit of the first embodiment;

FIG. 5 is a diagram showing an example of a timing chart for a case where carries for the input address A[10:2] are generated in the address generating circuit of the first embodiment;

FIG. 6 is a diagram showing a setting example of burst sequence in an operation mode of DRAM;

FIG. 7 is a diagram showing a function block corresponding to the entire configuration of the address generating circuit of FIG. 1;

FIG. 8 is a diagram showing a function block assumed when achieving the equivalent function to FIG. 7 using the conventional configuration including carry look-ahead circuits for the purpose of comparing with FIG. 7;

FIG. 9 is a diagram showing an entire configuration of an address generating circuit of a second embodiment;

FIG. 10 is a diagram showing an example of a timing chart for a case where no carry is generated for an input address A[10:2] in the address generating circuit of the second embodiment;

FIG. 11 is a diagram showing an example of a timing chart for a case where carries for the input address A[10:2] are generated in the address generating circuit of the second embodiment;

FIG. 12 is a diagram showing an entire configuration of the conventional address generating circuit;

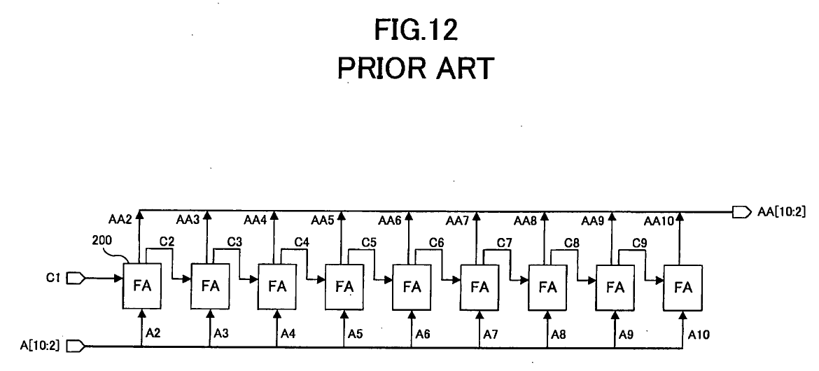

FIG. 13 is a diagram showing an entire configuration of the conventional address generating circuit for achieving high-speed operation with carry;

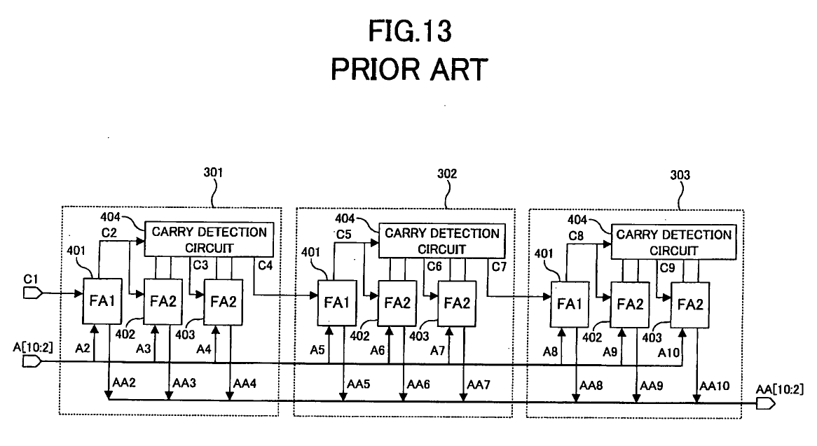

FIG. 14 is a diagram showing a timing chart of the address generating circuit of FIG. 12; and

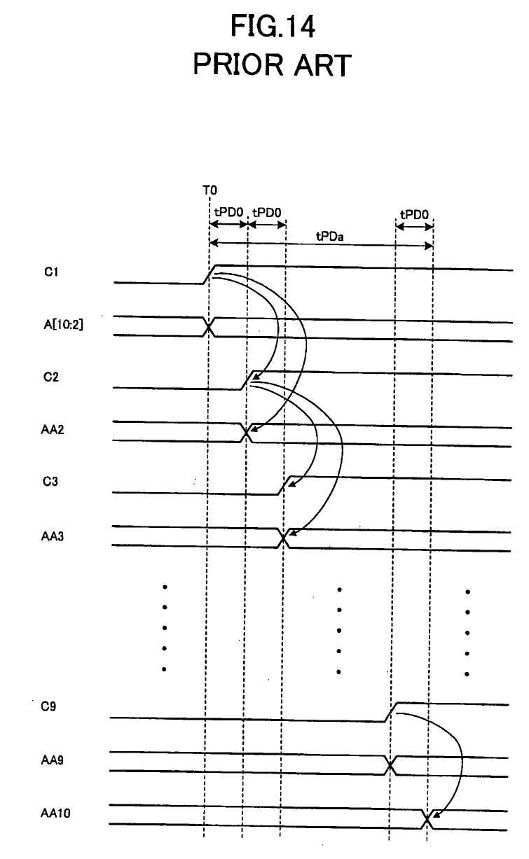

FIG. 15 is a diagram showing a timing chart of the address generating circuit of FIG. 13.

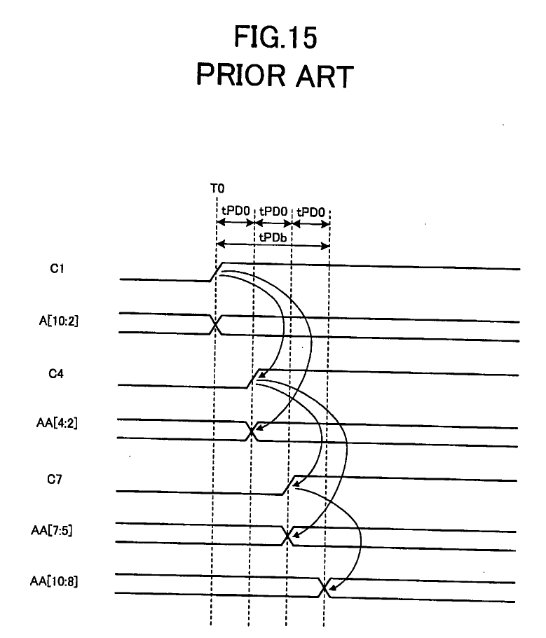

### DETAILED DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposes. In the following, two embodiments having different configurations will be described respectively, in which the present invention is applied to DRAM (Dynamic Random Access Memory) as a semiconductor memory device.

### First Embodiment

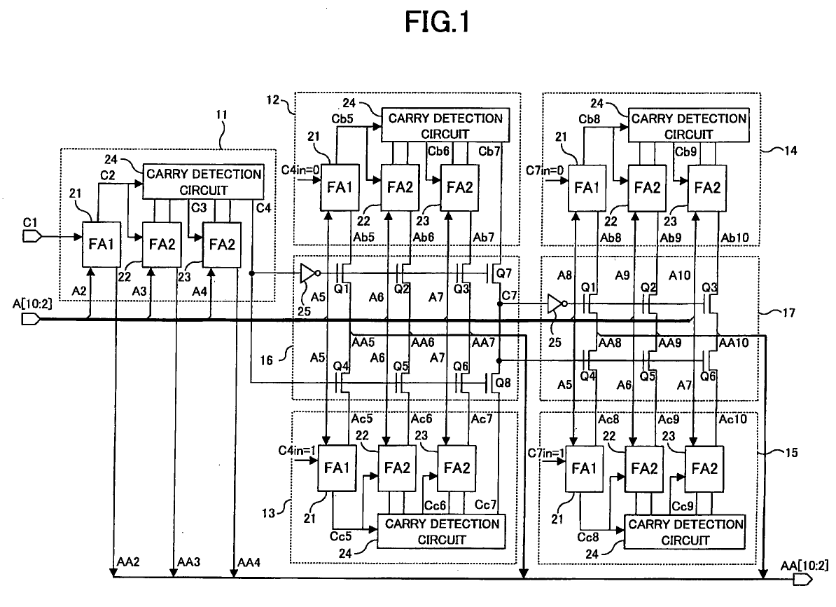

A first embodiment of the invention will be described below. FIG. 1 is a block diagram showing an entire configuration of an address generating circuit for generating an address corresponding to a function mode of DRAM in the first embodiment. The address generating circuit of the first embodiment receives a nine-digit input address A[10:2] and a carry C1, and generates and outputs a nine-digit output address AA[10:2] suitable for a function mode. In the DRAM in which the address generating circuit of the first embodiment is implemented, it is assumed that a lower two-digit input address A[1:0] of an eleven-digit address A[10:0] and a corresponding carry are generated separately based on four-bit prefetch function. Then, the nine-digit input address A[10:2] is divided into segments each composed of three digits, which are an upper input address A[10:8], a middle input address A[7:5] and a lower input address A[4:2], and each input address functions as a divided input address. Similarly, the nine-digit output address AA[10:2] is divided into segments each composed of three digits, which are an upper output address AA[10:8], a middle output address AA[7:5] and a lower output address AA[4:2], and each input address functions as a divided output address.

As shown in FIG. 1, the address generating circuit of the first embodiment includes five carry look-ahead circuits 11, 12, 13, 14 and 15, and two selector units 16 and 17. Among these, the least significant carry look-ahead circuit 11 independently functions as an address operation circuit. Further, two carry look-ahead circuits 12, 13 and the selector unit 16 integrally function as the address operation circuit. Furthermore, two carry look-ahead circuits 14, 15 and the selector unit 17 integrally function as the address operation circuit. That is, the address generating circuit of FIG. 1 has a configuration in which three address operation circuits are connected in three stages. In addition, the selector units 16 and 17 function as select circuits of the invention.

In the above configuration, the carry look-ahead circuit 11 receives the lower input address A[4:2] and the carry C1 and outputs the lower output address AA[4:2]. The carry look-ahead circuit 12 receives the middle input address A[7:5] and outputs the middle address Ab[7:5]. The carry look-ahead circuit 13 receives the middle input address A[7:5] and outputs the middle address Ac[7:5]. The carry look-ahead circuit 14 receives the upper input address A[10:8] and outputs the upper address Ab[10:8]. The carry look-ahead circuit 15 receives the upper input address A[10:8] and outputs the upper address Ac[10:8]. Here, in the carry look-ahead circuits 12 and 14, the respective carry inputs C4 in and C7 in are previously fixed to 0, and in the carry look-ahead circuits 13 and 15, the respective carry inputs C4 in and C7 in are previously fixed to 1.

The selector unit 16 receives the middle address Ab[7:5] outputted from the carry look-ahead circuit 12 with C4in=0 and the middle address Ac[7:5] outputted from the carry look-ahead circuit 13 with C4in=1, and selectively outputs one address thereof as the middle output address AA[7:5] based on the carry C4 outputted from the carry look-ahead circuit 11. The selector unit 17 receives the upper address Ab[10:8] outputted from the carry look-ahead circuit 14 with C7in=0 and the upper address Ac[10:8] outputted from the carry look-ahead circuit 15 with C7in=1, and selectively outputs one address thereof as the upper output address AA[10:8] based on the carry C7 outputted from selector unit 16. In this manner, the lower output address AA[4:2] from the carry look-ahead circuit 11, the middle output address AA[7:5] from the selector unit 16, and the upper output address AA[10:8] from the selector unit 17 integrally form the nine-digit output address AA[10:2], which is outputted from the address generating circuit.

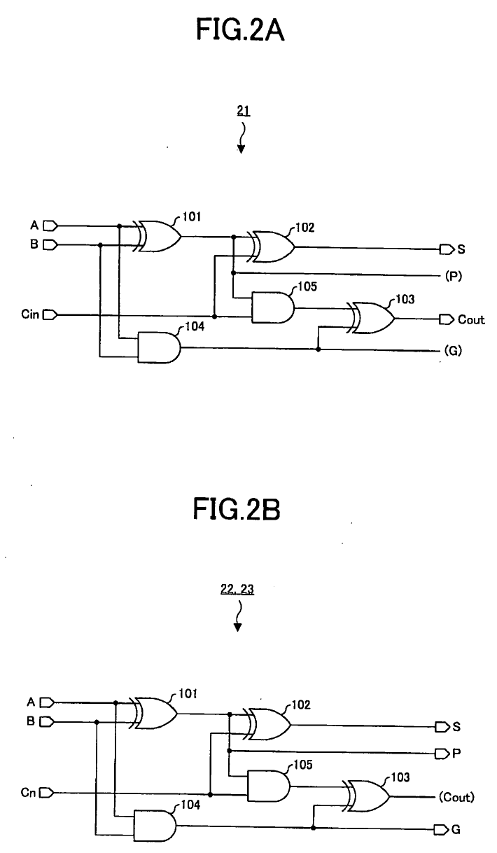

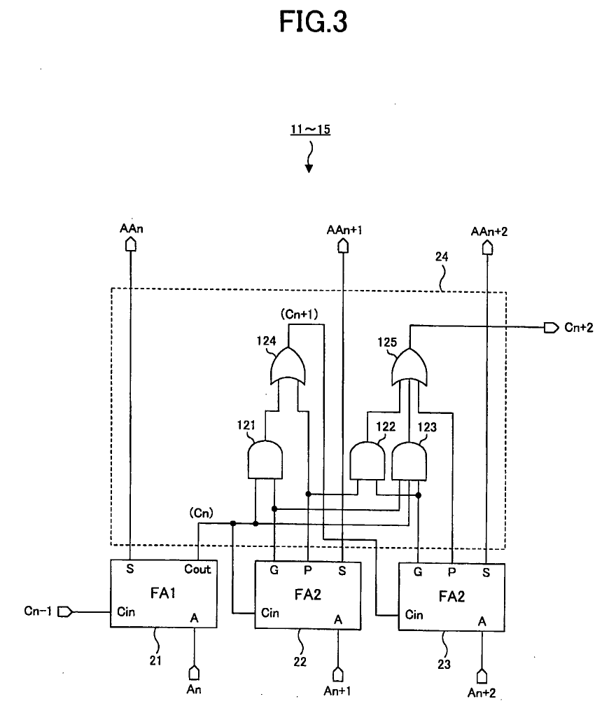

By focusing attention on the five carry look-ahead circuits 11 to 15, they have different combinations of input/output addresses and carries, however they have a common circuit configuration including one first full adder 21 (represented as FA1), two second full adders 22 and 23 (represented as FA2) and one carry detection circuit 24. In the following, the circuit configuration of the carry look-ahead circuits 11 to 15 will be described with reference to FIGS. 2 and 3.

FIGS. 2A and 2B show circuit configurations of the first full adder 21 and the second full adders 22 and 23 included in the carry look-ahead circuits 11 to 15. The first full adder 21 shown in FIG. 2A is composed of EXOR gates 101, 102 and 103, and AND gates 104 and 105. Two inputs A and B are inputted to the EXOR gate 101 and the AND gate 104 respectively. Here, the input A corresponds to one bit of the input address A of FIG. 1, while a fixed value is given to the input B. The EXOR gate 102 receives the output of the EXOR gate 101 and the carry input Cin, and outputs an output S which is a sum of the inputs A and B. The EXOR gate 103 receives outputs of the AND gates 104 and 105, and outputs a carry output Cout. Meanwhile, in the first full adder 21, an output P as an output of the EXOR gate 101 and an output G as an output of the AND gate 104 are both not used.

On the other hand, each of the second full adders 22 and 23 shown in FIG. 2B is composed of the EXOR gates 101, 102 and 103 and the AND gates 104 and 105 similarly as in the first full adder 21. However, the input and output configuration of the second full adders 22 and 23 differs from that of the first full adder 21. That is, in the second full adders 22 and 23, the outputs P and G which are not used in the first full adder 21 are outputted in addition to the output S, while the above carry output Cout is not used. Here, each of the second full adders 22 and 23 receives the input A corresponding to one bit of the input address A and receives the input B to which a fixed value is given, similarly as in the first full adder 21.

FIG. 3 shows a circuit configuration of the carry detection circuit 24 included in each of the carry look-ahead circuits 11 to 15, and also shows a connection relation in each of the carry look-ahead circuits 11 to 15. As shown in FIG. 3, the carry detection circuit 24 is composed of AND gates 121, 122 and 123, and OR gates 124 and 125. Each of the first full adder 21 and the two second full adders 22 and 23 receives addresses An, An+1 and An+2 of successive three bits as the input A, and outputs addresses AAn, AAn+1 and AAn+2 of successive three bits as the output S.

A carry Cn−1 is inputted as the carry input Cin of the first full adder 21, and a carry Cn is outputted as the carry output Cout of the first full adder 21. This carry Cn is inputted to the two AND gates 121 and 123 of the carry detection circuit 24, and inputted as the carry input Cin of one second full adder 22. The AND gate 121 outputs a logical product of the carry Cn and the output G of the second full adder 22, and the OR gate 124 outputs a logical sum of the output of the AND gate 121 and the output P of the second full adder 22 as the carry Cn+1. This carry Cn+1 is outputted as the carry input Cin of the other second full adder 23.

The AND gate 122 outputs a logical product of the output P of the second full adder 22 and the output G of the second full adder 23. The AND gate 123 outputs a logical product of the above carry Cn, the output G of the second full adder 22 and the output G of the second full adder 23. The OR gate 125 outputs a logical sum of respective outputs of the AND gates 122 and 123 and the output P of the second full adder 23 to outside as the carry Cn+2. In the carry look-ahead circuits 11 to 15, three-digit carries Cn, Cn+1 and Cn+2 can be generated together for the successive three-bit addresses An, An+1 and An+2 without propagating carries sequentially.

Returning to FIG. 1, the carries Cn, Cn+1 and Cn+2 as shown in FIG. 3 correspond to the carries C2, C3 and C4 of the lower carry look-ahead circuit 11, and also correspond to the carries Cb5, Cb6 and Cb7 of the middle carry look-ahead circuit 12 and the carries Cc5, Cc6 and Cc7 of the middle carry look-ahead circuit 13, respectively. Meanwhile, carries Cb10 and Cc10 corresponding to the carry Cn+2 are not used in the upper carry look-ahead circuits 14 and 15, and the carries Cn and Cn+1 correspond to carries Cb8 and Cb9 of the carry look-ahead circuit 14 and carries Cc8 and Cc9 of the carry look-ahead circuit 15 respectively.

Next, a circuit configuration of the selector units 16 and 17 will be described. As shown in FIG. 1, the selector unit 16 of the preceding stage includes one inverter 25, six transistors Q1 to Q6, and two transistors Q7 and Q8. For example, NMOS type transistors are used as the transistors Q1 to Q8. An inverted signal of the carry C4 is coupled to each gate of the transistors Q1 to Q3 and Q7 via the inverter 25, and the carry C4 is directly coupled to each gate of the transistors Q4 to Q6 and Q8. Addresses Ab5, Ab6 and Ab7 of the carry look-ahead circuit 12 with C4in=0 are coupled to respective one ends of the transistors Q1, Q2 and Q3. Further, addresses Ac5, Ac6 and Ac7 of the carry look-ahead circuit 12 with C4in=1 are coupled to respective one ends of the transistors Q4, Q5 and Q6.

The transistors Q1 and Q4 are connected in series, and an output address AA5 is outputted from the intermediate node of the transistors Q1 and Q4. Similarly, the transistors Q2 and Q5 are connected in series, and an output address AA6 is outputted from the intermediate node of the transistors Q2 and Q5. Also the transistors Q3 and Q6 are connected in series, and an output address AA7 is outputted from the intermediate node of the transistors Q3 and Q6. In this configuration, when the carry C4 of the input side is 0, the transistors Q1, Q2 and Q3 are turned on, and the transistors Q4, Q5 and Q6 are turned off, so that the addresses Ab5, Ab6 and Ab7 of the carry look-ahead circuit 12 are outputted as the output addresses AA5, AA6 and AA7. On the other hand, when the carry C4 of the input side is 1, the transistors Q1, Q2 and Q3 are turned off, and the transistors Q4, Q5 and Q6 are turned on, so that the addresses Ac5, Ac6 and Ac7 of the carry look-ahead circuit 13 are outputted as the output addresses AA5, AA6 and AA7.

Meanwhile, the carry Cb7 of the carry look-ahead circuit 12 is coupled to one end of the transistor Q7, and the carry Cc7 of the carry look-ahead circuit 13 is coupled to one end the transistor Q8. Then, the carry C7 is outputted from the intermediate node of series connected transistors Q7 and Q8. When the carry C4 of the input side is 0, the transistor Q7 is turned on and the transistor Q8 is turned off, so that the carry Cb7 of the carry look-ahead circuit 12 is outputted as the carry C7. On the other hand, when the carry C4 of the input side is 1, the transistor Q7 is turned off and the transistor Q8 is turned on, so that the carry Cc7 of the carry look-ahead circuit 13 is outputted as the carry C7.

The selector unit 17 of the subsequent stage includes one inverter 25 and six transistors Q1 to Q6 in the same manner as the selector unit 16, and since the carry from the address generating circuit of the last stage needs not to be propagated to the subsequent stage, the transistors Q7 and Q8 are not included. In the selector unit 17, an area including the inverter 25 and the transistors Q1 to Q6 is configured in the same manner as in the selector unit 16 if the carry C4 is replaced with the carry C7 and the addresses Ab5 to Ab7, Ac5 to Ac7, AA5 to AA7 are replaced with the addresses Ab8 to Ab10, Ac8 to Ac10, AA8 to AA10 respectively, so description thereof will be omitted.

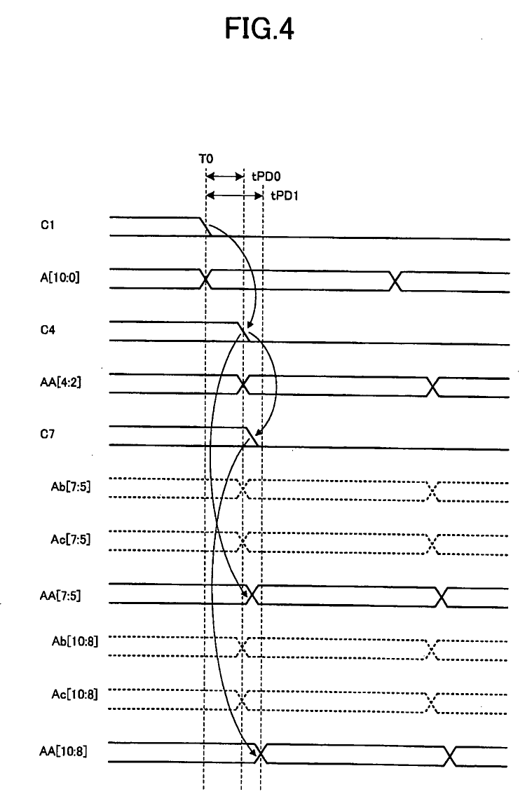

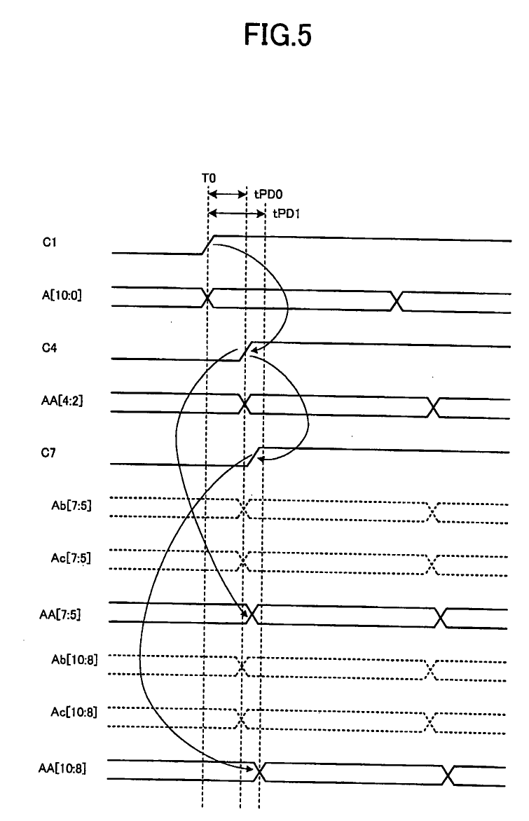

Next, operation of the address generating circuit of the first embodiment will be described with reference to FIGS. 4 and 5. FIG. 4 shows an example of a timing chart for a case where no carry is generated for the input address A[10:2] in the address generating circuit. First, considering the timing T0 to be a starting point, the carry C1 from outside is determined to be 0, and the eleven-digit address A[10:0] is determined, among which the nine-digit input address A[10:2] is inputted to the address generating circuit. Thereby, an arithmetic operation in the carry look-ahead circuit 11 is started, and arithmetic operations in the carry look-ahead circuits 12 to 15 with previously fixed carry inputs C4 in and C7 in are also started.

When the time tPD0 required for the arithmetic operations in the carry look-ahead circuits 11 to 15 is elapsed from the timing T0, the lower output address AA[4:2] is determined and the carry C4 is changed and determined to be 0 in the carry look-ahead circuit 11. At this point, the addresses Ab[7:5], Ac[7:5], Ab[10:8] and Ac[10:8] and the carries Cb4, Cc4, Cb7 and Cc7 which are outputted from the carry look-ahead circuits 12 to 15 are determined simultaneously. The subsequent timing of the operation depends on selection operation in the selector units 16 and 17.

After the carry C4 is determined to be 0, the middle address Ab[7:5] is selectively outputted as the middle output address AA[7:5] through the transistors Q1 to Q3, and the carry Cb7 is selectively outputted as the carry C7 through the transistor Q7, respectively in the selector unit 16. Further, after the carry C7 is determined to be 0, the upper address Ab[10:8] is selectively outputted as the upper output address AA[10:8] through the transistors Q1 to Q3 in the selector unit 17. This operation is completed at the point when a time tPD1 is elapsed from the timing T0 in the selector units 16 and 17. The time tPD1 is longer than the above time tPD0 by an amount corresponding to two selection operations in the selector units 16 and 17.

Meanwhile, FIG. 5 shows an example of a timing chart for a case where carries for the input address A[10:2] are generated in the address generating circuit. The carry C1 inputted from outside is determined to be 1 and the eleven-digit address A[10:0] is determined, respectively at the timing T0 (the same timing T0 is shown in FIG. 4). By comparing FIG. 5 with FIG. 4, changes in the respective carries C1 are reverse to each other. In this state of the address generating circuit, the arithmetic operations in the carry look-ahead circuits 11 to 15 are started, and the lower output address AA[4:2], the carry C4, the addresses Ab[7:5], Ac[7:5], Ab[10:8] and Ac[10:8], and the carries Cb7 and Cc7 are determined simultaneously when the time tPD0 which is the same as in FIG. 4 is elapsed. The subsequent timing of the operation depends on selection operation in the selector units 16 and 17.

After the carry C4 is determined to be 1, the middle address Ac[7:5] is selectively outputted as the middle output address AA[7:5] through the transistors Q4 to Q6, and the carry Cc7 is selectively outputted as the carry C7 through the transistor Q8 in the selector unit 16. Further, after the carry C7 is determined to be 1, the upper address Ac[10:8] is selectively outputted as the upper output address AA[10:8] through the transistors Q4 to Q6, respectively in the selector unit 17. This operation is completed at the point when the above time tPD1 which is the same as in FIG. 4 is elapsed from the timing T0.

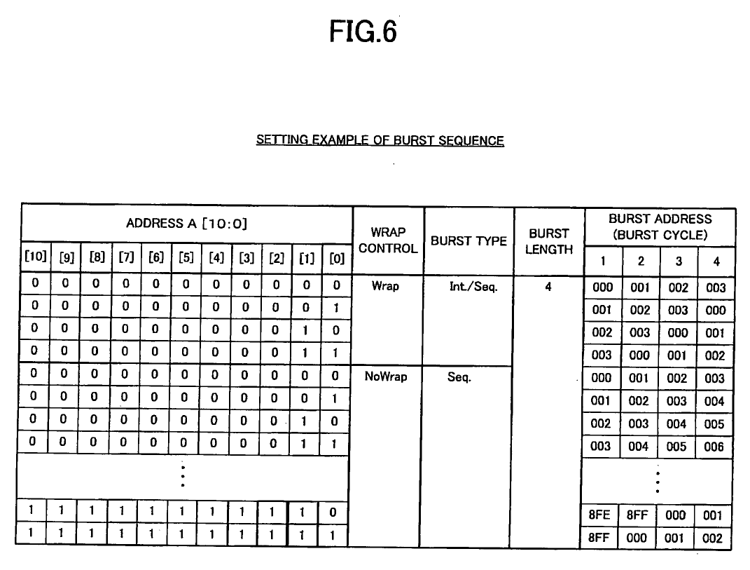

Next, an application example of the address generating circuit of the first embodiment will be described. The address generating circuit of the first embodiment can be used as, for example, a circuit having address increment function suitable for an operation mode of DRAM. FIG. 6 shows a setting example of burst sequence in the operation mode of DRAM. Generally, the burst sequence is an operation mode for inputting/outputting date sequence of successive addresses in synchronization with a clock signal. The setting data relating to the burst sequence is stored in a mode register of DRAM.

In FIG. 6, as the setting data of the burst sequence, there are shown patterns of the eleven-digit address A[10:0] inputted to the address generating circuit, wrap control (mode), burst type, burst length, and burst addresses for each burst cycle. There are two modes for the wrap control, including Wrap mode in which only lower two bits of an address generated in the address generating circuit are shifted while the upper address is fixed, and including NoWrap mode in which the upper address is shifted in addition to the lower two bits. There are burst types including sequential type (Seq.) for incrementing the address sequentially and including interleave type (Int.) for interleaving and shifting the address. The burst length indicates the number of data being input/output successively, and is set to 4 in the example of FIG. 6.

Since the lower two-digit input address A[1:0] is generated based on the four-bit prefetch function as described above, the upper nine-digit input address A[10:2] is inputted to the address generating circuit, and the output address AA[10:2] is generated as an operation result. As shown in FIG. 6, burst addresses (hexadecimal) are shown, each of which includes the address A[10:0] set as a start address whose upper nine digits is the input address A[10:2], and is incremented sequentially in four burst cycles. In the NoWrap mode, for example, a carry is generated in the address A[2] when the burst address is shifted from 003 to 004.

As described above, by using the address generating circuit of the first embodiment, it is possible to generate successive addresses at high speed when inputting addresses each having the large number of digits and performing operation with carry such as increment operation. As shown in FIG. 1, the carry look-ahead circuits 11 to 15 which are separated to have predetermined digits respectively are operated individually, each of which performs the carry detection. Therefore, it is possible to reduce the time required to wait for the carry of the lower address when performing an addition of arbitrary digits. In each configuration of the carry look-ahead circuits 11 to 15, a circuit sequence of the carry look-ahead circuits 12 and 14 in which the input carry fixed to 0 is assumed, and a circuit sequence of the carry look-ahead circuits 13 and 15 in which the input carry fixed to 1 is assumed, are separated from each other, without transferring the carry from the lower side to the upper side, thereby selectively using operation results of the two circuit sequences in accordance with actual carries. Therefore, higher speed arithmetic operation of the address can be achieved with small circuit scale without providing a complex configuration such as a multiplexer.

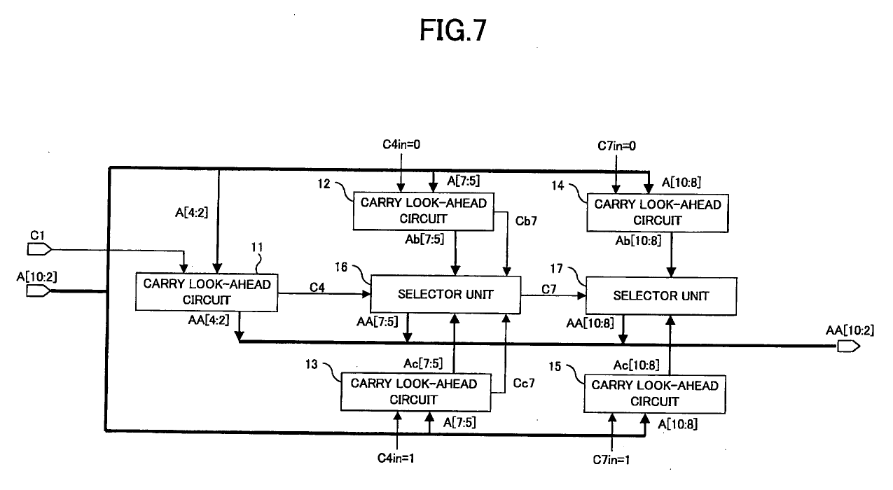

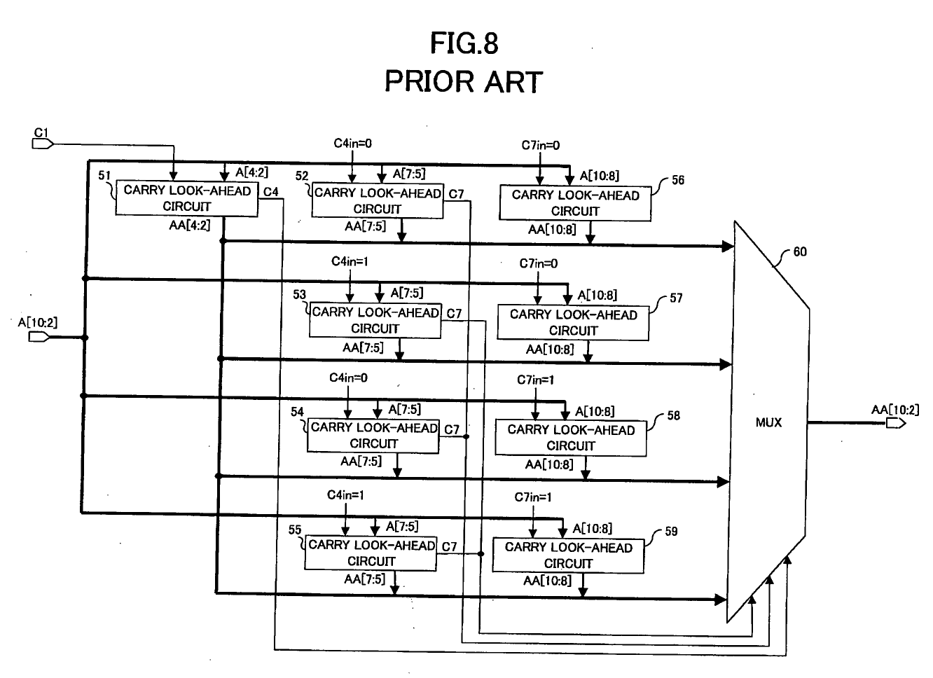

Here, structural effects of the first embodiment will be described with reference to FIGS. 7 and 8. FIG. 7 shows a function block corresponding to the entire configuration of the address generating circuit of FIG. 1. FIG. 8 shows a function block assumed when achieving the equivalent function to FIG. 7 using the conventional configuration including carry look-ahead circuits for the purpose of comparing with FIG. 7.

In FIG. 7, the address generating circuit is configured by the five carry look-ahead circuits 11 to 15 and the two selector units 16 and 17, as described above, which generates the nine-digit output address AA[10:2] based on the nine-digit input address A[10:2]. On the other hand, in FIG. 8, an address generating circuit is configured by using nine carry look-ahead circuits 51 to 59 and a multiplexer (MUX) 60 so that the address generating circuit having the equivalent function to FIG. 7 is configured. That is, there are provided the carry look-ahead circuit 51 receiving the lower input address A[4:2] and outputting the lower output address AA[4:2], four carry look-ahead circuits 52 to 55 receiving the middle input address A[7:5] and outputting the middle output address AA[7:5], four carry look-ahead circuits 56 to 59 receiving the upper input address A[10:8] and outputting the upper output address AA[10:8], and the multiplexer 60 for selectively outputting the output address AA[10:2] via four paths based on the carries C4 and C7.

In the configuration of FIG. 8, the four paths for the output address AA[10:2] correspond to four types of combinations of the carry inputs C4 in and C7 in for the carry look-ahead circuits 52 to 59. Specifically, there are a path of the carry look-ahead circuits 52 and 56 with C4in=0 and C7in=0, a path of the carry look-ahead circuits 53 and 57 with C4in=1 and C7in=0, a path of the carry look-ahead circuits 54 and 58 with C4in=0 and C7in=1, and a path of the carry look-ahead circuits 55 and 59 with C4in=1 and C7in=1. The multiplexer 60 selects one of the above four paths in response to the carry C4 outputted from the carry look-ahead circuit 51 and the carry C4 outputted from the carry look-ahead circuits 52 to 55, and outputs the nine-digit output address AA[10:2] via the corresponding path.

It is apparent from a comparison of the configurations of FIGS. 7 and 8, five carry look-ahead circuits 11 to 15 are provided in the first embodiment (FIG. 7), while nine carry look-ahead circuits 51 to 59 need to be provided in the conventional configuration (FIG. 8). Further, in the first embodiment, the selector units 16 and 17 are provided, while the multiplexer 60 as shown in FIG. 8 is not required to be provided, since selection of the four paths for the output address AA[10:2] is not required, so that higher-speed operation can be performed. In this manner, the entire circuit scale of FIG. 7 is sufficiently reduced relative to FIG. 8 and thus it is effective to reduce the area and suitable for higher-speed operation.

### Second Embodiment

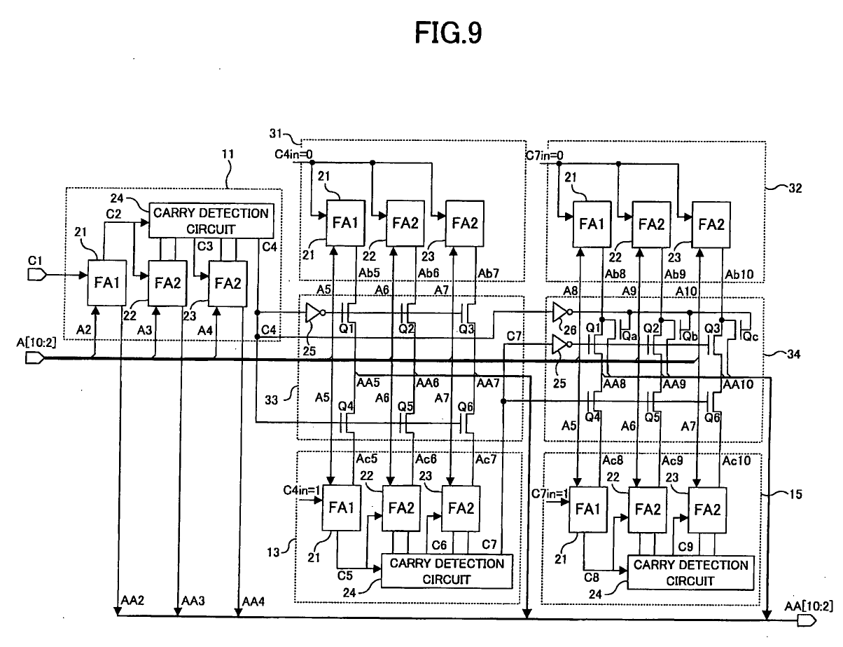

In the following, a second embodiment of the invention will be described. FIG. 9 is a block diagram showing an entire configuration of the address generating circuit of the second embodiment which has the same function as the first embodiment. The address generating circuit of the second embodiment receives the nine-digit input address A[10:2] and the carry C1, and generates and outputs the nine-digit output address AA[10:2] suitable for the function mode, similarly as in the first embodiment. The address generating circuit of the second embodiment includes five carry look-ahead circuits 11, 13, 15, 31 and 32, and two selector units 33 and 34. Among these, the carry look-ahead circuits 11, 13 and 15 are configured in the same manner as in FIG. 1 for the first embodiment, so description thereof will be omitted.

Each of the carry look-ahead circuits 31 and 32 includes the first full adder 21 and the second full adders 22 and 23 and differ from FIG. 1 in that they do not include the carry detection circuit 24. The first full adder 21 and the second full adders 22 and 23 have the same circuit configurations as in FIGS. 2A and 2B, and the carry input Cin fixed to 0 is commonly coupled to the second full adders 22 and 23 as well as the first full adder 21.

The selector unit 33 includes the inverter 25 and the transistors Q1 to Q6 which are the same as in the selector unit 16 of FIG. 1, however does not include the transistors Q7 and Q8 on the output side. The selector unit 33 receives the middle address Ab[7:5] of one carry look-ahead circuit 31 and the middle address Ac[7:5] of the other carry look-ahead circuit 13, and selectively outputs one address thereof as the middle output address AA[7:5] based on the carry C4 outputted from the carry look-ahead circuit 11. As different from FIG. 1, the carry C7 is not selectively outputted from the selector unit 33 and is directly propagated from the carry look-ahead circuit 13 to the selector unit 34.

Meanwhile, an inverter 26 and transistors Qa, Qb and Qc are added to the selector unit 34, in addition to the inverter 25 and the transistors Q1 to Q6 being the same as in the selector unit 33. In the selector unit 33, an inverted signal of the carry C7 is coupled to each gate of the transistors Q1 to Q3 via the inverter 25, and the carry C7 is directly coupled to each gate of the transistors Q4 to Q6. Further, an inverted signal of the carry C4 outputted from the carry look-ahead circuit 11 is coupled to each gate of the transistors Qa, Qb and Qc connected in parallel with the transistors Q1 to Q3 respectively.

According to the configuration shown in FIG. 9, appropriate selection operation can be performed in the selector unit 34 in accordance with a combination of the carries C4 and C7 of the carry look-ahead circuits 11 and 13 without providing the carry detection circuit 24 in the carry look-ahead circuits 31 and 32. In this case, the number of components in the selector unit 34 slightly increases, however the circuit scale of the carry look-ahead circuits 31 and 32 and the selector unit 33 can be sufficiently reduced.

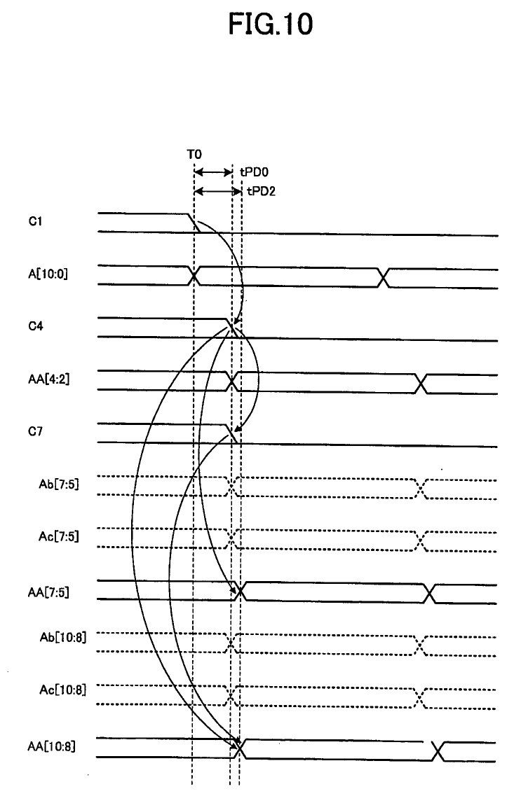

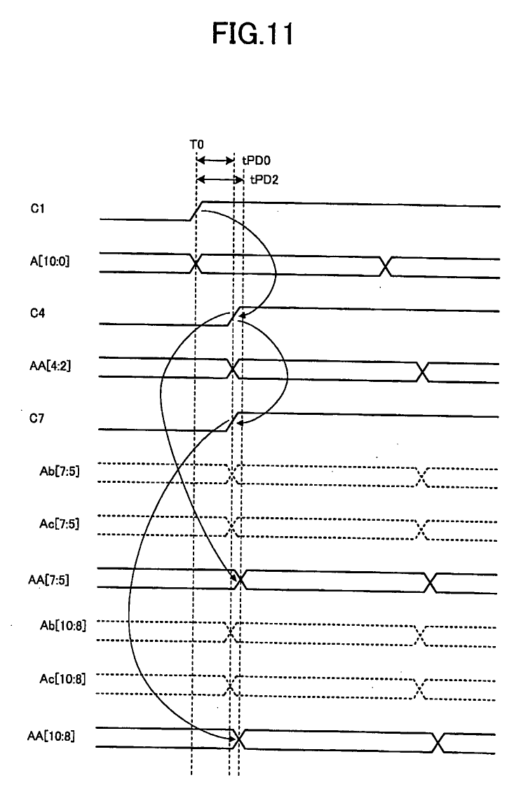

Next, operation of the address generating circuit of the second embodiment will be described with reference to FIGS. 10 and 11. FIG. 10 shows an example of a timing chart for a case where no carry is generated for the input address A[10:2] in the address generating circuit. First, considering the timing T0 to be a starting point, the carry C1 from outside is determined to be 0, and the eleven-digit address A[10:0] is determined, among which the nine-digit input address A[10:2] is inputted to the address generating circuit. Thereby, an arithmetic operation in the carry look-ahead circuit 11 is started, and arithmetic operations in the carry look-ahead circuits 31, 32, 13 and 15 are also started.

When the time tPD0 required for the arithmetic operations in the carry look-ahead circuits 31, 32, 13 and 15 is elapsed from the timing T0, the lower output address AA[4:2] is determined and the carry C4 is changed and determined to be 0 in the carry look-ahead circuit 11. At this point, the addresses Ab[7:5], Ac[7:5], Ab[10:8] and Ac[10:8] and the carry C7 which are outputted from the carry look-ahead circuits 31, 32, 13 and 15 are determined simultaneously. The subsequent timing of the operation depends on selection operation in the selector units 33 and 34.

After the carry C4 is determined to be 0, the middle address Ab[7:5] is selectively outputted as the middle output address AA[7:5] through the transistors Q1 to Q3 in the selector unit 33. Then, after the carries C4 and C7 are determined to be 0, the upper address Ab[10:8] is selectively outputted as the upper output address AA[10:8] in the selector unit 34. This operation is completed at the point when a time tPD2 is elapsed from the timing T0. Since the time tPD2 corresponds to a single selection operation in the selector units 33 and 34, the time tPD2 is shorter than the time tPD1 in FIG. 4.

Meanwhile, FIG. 11 shows an example of a timing chart for a case where carries for the input address A[10:2] are generated in the address generating circuit. The carry C1 inputted from outside is determined to be 1 and the eleven-digit address A[10:0] is determined, respectively at the timing T0 (the same timing T0 is shown in FIG. 10). By comparing FIG. 11 with FIG. 10, changes in the respective carries C1 are reverse to each other. In this state of the address generating circuit, the arithmetic operations in the carry look-ahead circuits 11, 13, 15, 31 and 32 are started, and the lower output address AA[4:2], the carry C4, the addresses Ab[7:5], Ac[7:5], Ab[10:8] and Ac[10:8] and the carry C7 are determined simultaneously when the time tPD0 which is the same as in FIG. 10 is elapsed. The subsequent timing of the operation depends on selection operation in the selector units 33 and 34.

After the carry C4 is determined to be 1, the middle address Ac[7:5] is selectively outputted as the middle output address AA[7:5] through the transistors Q4 to Q6 in the selector unit 33. Then, after the carries C4 and C7 are determined to be 1, the upper address Ac[10:8] is selectively outputted as the upper output address AA[10:8] in the selector unit 34. This operation is completed at the point when the time tPD2 corresponding to a single selection operation in the selector units 33 and 34 is elapsed from the timing T0, similarly as in FIG. 10.

As described above, basic operation and effect of the address generating circuit of the second embodiment are common to those in the first embodiment, and additionally the effect of reducing the circuit scale can be larger since the carry detection circuit 24 is not required to be provided in the carry look-ahead circuits 31 and 32 of the second embodiment. Further, since the carry C4 is directly inputted to the select circuit 17, the addition arithmetic operation with carry can be performed at further higher speed.

In the foregoing, the present invention has been specifically described based on the embodiments, however the present invention is not limited to the above-described embodiments, and various variations and modifications can be made without departing from the scope of the present invention. For example, in the above embodiments, each of the input address A and the output address AA is configured to be divided into three segments, and corresponding three address operation circuits are connected in multiple stages. However, the present invention can be applied to a configuration in which each of the input address A and the output address AA is divided into N (N is an integer greater than or equal to 2) segments and N address operation circuits are connected in multiple stages. In this configuration, at least one address operation circuit (all N address operation circuit may be possible) among the N address operation circuits may be configured to include a first carry look-ahead circuit, a second carry look-ahead circuit and a select circuit in order to perform the above operation with carry, thereby obtaining the effect of the present invention.

It is apparent that the present invention is not limited to the above embodiments, but may be modified and changed without departing from the scope and spirit of the invention.

What is claimed is:

1. An address generating circuit comprising:
a first carry look-ahead circuit for performing an operation using an inputted first carry and a first address and outputting a first output address and a first output carry respectively as a first operation result;
a second carry look-ahead circuit for performing an operation using a carry fixed to 0 and a second address and outputting a second output address and a second output carry respectively as a second operation result;
a third carry look-ahead circuit for performing an operation using a carry fixed to 1 and the second address and outputting a third output address and a third output carry respectively as a third operation result; and
a first select circuit for selecting either of the second and third operation results based on the first output carry and outputting the selected operation result.

2. The address generating circuit according to claim 1 further comprising:
a fourth carry look-ahead circuit for performing an operation using a carry fixed to 0 and a third address and outputting a fourth output address and a fourth output carry respectively as a fourth operation result;
a fifth carry look-ahead circuit for performing an operation using a carry fixed to 1 and the third address and outputting a fifth output address and a fifth output carry respectively as a fifth operation result; and
a second select circuit for selecting either of the fourth and fifth operation results based on an output of the first select circuit and outputting the selected operation result.

3. The address generating circuit according to claim 2, wherein the second select circuit selects and outputs the fourth operation result based on the first output carry when the first output carry is 0, and selects either of the fourth and fifth operation results based on the output of the first select circuit and outputs the selected operation result when the first output carry is 1.

4. The address generating circuit according to claim 3, wherein an output terminal is provided from which the first output address is outputted without passing through the select circuit.

5. The address generating circuit according to claim 2, wherein an input address is divided into N (N is greater than or equal to 2) addresses at least including the first to third addresses.

6. The address generating circuit according to claim 2, wherein each of the first to fifth carry look-ahead circuits performs a predetermined arithmetic operation with carry.

7. The address generating circuit according to claim 6, wherein the predetermined arithmetic operation with carry is addition with carry.

8. The address generating circuit according to claim 7, wherein each of the first to fifth carry look-ahead circuits includes a plurality of full adders for performing the addition with carry corresponding to a digits number of the address and a carry detection circuit for detecting the carry.

9. An address generating circuit comprising:
a first carry look-ahead circuit for performing an operation using an inputted first carry and a first address and outputting a first output address and a first output carry respectively as a first operation result;
a second carry look-ahead circuit for performing an operation using a carry fixed to 0 and a second address and outputting a second output address and a second output carry respectively as a second operation result;
a third carry look-ahead circuit for performing an operation using a carry fixed to 1 and the second address and outputting a third output address and a third output carry respectively as a third operation result; and
a first select circuit including a first switch connected to the first carry look-ahead circuit and a second switch connected to a second carry look-ahead circuit, and outputting a selected operation result through either of the first and second switches which are controlled on/off by signals reverse to each other.

10. The address generating circuit according to claim 9 further comprising:
a fourth carry look-ahead circuit for performing an operation using a carry fixed to 0 and a third address and outputting a fourth output address and a fourth output carry respectively as a fourth operation result;
a fifth carry look-ahead circuit for performing an operation using a carry fixed to 1 and the third address and outputting a fifth output address and a fifth output carry respectively as a fifth operation result; and
a second select circuit including a third switch connected to the fourth carry look-ahead circuit and a fourth switch connected to a fifth carry look-ahead circuit, and outputting a selected operation result through either of the third and fourth switches which are controlled on/off by signals reverse to each other.

11. The address generating circuit according to claim 10, wherein the second select circuit selects and outputs the fourth operation result based on the first output carry when the first output carry is 0, and selects either of the fourth and fifth operation results based on the output of the first select circuit and outputs the selected operation result when the first output carry is 1.

12. The address generating circuit according to claim 11, wherein an output terminal is provided from which the first output address is outputted without passing through the select circuit.

13. The address generating circuit according to claim 10, wherein an input address is divided into N (N is greater than or equal to 2) addresses at least including the first to third addresses.

14. The address generating circuit according to claim 10, wherein each of the first to fifth carry look-ahead circuits performs a predetermined arithmetic operation with carry.

15. The address generating circuit according to claim 14, wherein the predetermined arithmetic operation with carry is addition with carry.

16. The address generating circuit according to claim 15, wherein each of the first to fifth carry look-ahead circuits includes a plurality of full adders for performing the addition with carry corresponding to a digits number of the address and a carry detection circuit for detecting the carry.

17. A semiconductor memory device comprising:
a first carry look-ahead circuit for performing an operation using an inputted first carry and a first address and outputting a first output address and a first output carry respectively as a first operation result;
a second carry look-ahead circuit for performing an operation using a carry fixed to 0 and a second address and outputting a second output address and a second output carry respectively as a second operation result;
a third carry look-ahead circuit for performing an operation using a carry fixed to 1 and the second address and outputting a third output address and a third output carry respectively as a third operation result; and
a first select circuit for selecting either of the second and third operation results based on the first output carry and outputting the selected operation result.

18. The semiconductor memory device according to claim 17 further comprising:
a fourth carry look-ahead circuit for performing an operation using a carry fixed to 0 and a third address and outputting a fourth output address and a fourth output carry respectively as a fourth operation result;
a fifth carry look-ahead circuit for performing an operation using a carry fixed to 1 and the third address and outputting a fifth output address and a third output carry respectively as a fifth operation result; and
a second select circuit for selecting either of the fourth and fifth operation results based on an output of the first select circuit and outputting the selected operation result.

19. The semiconductor memory device according to claim 18, wherein read and write operations are controlled based on the selected operation results of the first to fifth output addresses.

20. The semiconductor memory device according to claim 18, wherein successive addresses corresponding to burst sequence are outputted as the first to fifth output addresses.
